(19) United States
(12) Patent Application Publication
(10) Pub. No.: US 2006/0275204 A1
(43) Pub. Date: Dec. 7, 2006

(54) Process for the production of niobium oxide powder for use in capacitors

(75) Inventors: Solon Yasuhiko Tagusagawa, Sao Paulo (BR); Alberto Akikazu Ono, Araxa (BR); Flavio Neto Beneduce, Sao Paulo (BR); Joao Batista Neto Ferreira, Sao Paulo (BR)

Correspondence Address: BIRCH STEWART KOLASCH & BIRCH, PO BOX 747, FALLS CHURCH, VA, 22040-0747, US

(73) Assignees: COMPANHIA BRASILEIRA DE METALURGIA E MINERACAO, SAO PAULO (BR); IP-INSTITUTO DE PESQUISAS TECHNOLOGICAS DO ESTADO DE SAO PAULO S/A, SAO PAULO (BR)

(21) Appl. No.: 10/573,293

(22) PCT Filed: Jan. 23, 2004
(86) PCT No.: PCT/BR04/00003

§ 371 Date: Jun. 28, 2006

(30) Foreign Application Priority Data
Sep. 25, 2003 (BR) PI 0301252-9

(51) Int. Cl. C01G 31/02

(52) U.S. Cl. 423/594.17

(57) ABSTRACT

The present invention is related to a process for the production of a powder of niobium monoxide (NbO) having a high purity, large specific surface area, controlled oxygen and nitrogen contents and a morphology adequate for use in the manufacture of capacitors, characterized by comprising two niobium pentoxide (Nb₂O₅) reduction steps, the first step comprising reducing, by hydrogen, the niobium pentoxide (Nb₂O₅) to niobium dioxide (NbO₂), and the second step comprising reducing niobium dioxide (NbO₂) to niobium monoxide (NbO), by using an oxygen getter material in a convenient atmosphere which permits the transfer of the oxygen atoms from the niobium oxide (NbO₂) to the getter material, under adequate conditions of time and temperature to form the niobium monoxide (NbO). The particles of powder of niobium monoxide (NbO) produced using the instant process are small, have a large surface area and an appropriate morphology, and are adequate for the production of capacitors.

### BRIEF DESCRIPTION OF THE INVENTION

The present invention is related to a process for the production of niobium monoxide (NbO) powder characterized by two niobium pentoxide (Nb₂O₅) reduction steps, the first step comprising reducing, by hydrogen, of the niobium pentoxide (Nb₂O₅) to niobium dioxide (NbO₂), and the second step comprising reducing the niobium dioxide (NbO₂) to niobium monoxide (NbO), by using an oxygen getter material and in a convenient atmosphere allowing the transfer of the oxygen atoms from the niobium dioxide (NbO₂) to the getter material, under adequate conditions of time and temperature to form the niobium monoxide (NbO).

The partial reduction of niobium oxides, in one sole step, using refractory or reactive metals and/or hydrides of refractory or reactive metals as oxygen getter materials and in an atmosphere which allows the transfer of oxygen atoms is known in the art, as may be noted in patents Nos. U.S. Pat. No. 6,391,275, U.S. Pat. No. 6,416,730, and U.S. Pat. No. 6,462,934. However, the main problem of the partial reducing of niobium oxides in one sole step is the difficulty to obtain a product having only niobium monoxide in its composition, as may be noted in the above cited patents. This is due to the existence of the various states of oxidation that can be assumed by the niobium, as well as the innumerous niobium oxides that can be formed during the partial reduction in a single step. The existence of more than one type of niobium oxide or even of residual metallic niobium, in addition to the niobium monoxide, is deleterious for the use thereof in capacitors. Furthermore, the final morphology that is obtained is difficult to control and it is not usually the most adequate for the manufacture of high performance capacitors (high capacitance and low current leakage).

The reduction of the niobium pentoxide (Nb₂O₅) to niobium monoxide (NbO) in two steps allows a better control of each reducing step, allowing the use of the most convenient raw materials and the use of the most adequate equipment for each step of the process, thus lowering the production costs. And most importantly, this process allows a better control of the chemical, physical and morphological properties of the product obtained thereby.

In addition, since in the second processing step there is used niobium dioxide (NbO₂) and not niobium pentoxide (Nb₂O₅) as the raw material, the oxygen getter material undergoes a lesser oxidation, rendering the process more efficient and controlled, and allowing the use of lesser quantities of getter material.

Following this course, the niobium monoxide (NbO) may be reduced in a controlled manner, yielding a powder of high purity, porous, with controlled morphology, with low apparent density and large specific surface area.

### BRIEF DESCRIPTION OF THE DRAWINGS

FIG. 1: A photograph of a scanning electron microscopy of a niobium dioxide (NbO₂) agglomerate—Magnification of 5,000 times.

FIG. 2: A photograph of a scanning electron microscopy of a niobium dioxide (NbO₂) agglomerate—Magnification of 10,000 times.

FIG. 3: A photograph of a scanning electron microscopy of a niobium monoxide (NbO) agglomerate—Magnification of 800 times.

FIG. 4: A photograph of a scanning electron microscopy of a niobium monoxide (NbO) agglomerate—Magnification of 6,000 times.

### DETAILED DESCRIPTION OF THE INVENTION

The present invention is related to a process for the production of a powder of niobium monoxide (NbO) characterized by two niobium pentoxide (Nb₂O₅) reduction steps, wherein the lack of control of the reduction process which causes the detectable presence of other oxides of niobium or of residual metallic niobium is eliminated.

By using separate reduction steps, it is possible to control the driving force of the reaction whereby the niobium oxides are reduced due to the possibility of controlling the potential of the reducing agent in each step, allowing greater control of the process. The use of a raw material in the form of a powder, with adequate size and morphology, consisting basically in niobium pentoxide (Nb₂O₅) in the first step, and niobium dioxide (NbO₂) and a refractory metal or a reactive metal and/or hydrides thereof, of high purity, in the second step, permits to form niobium monoxide (NbO), with a controlled morphology, producing an adequate particle distribution without formation of agglomerates of undesirable size.

The reducing agent in the first step is hydrogen gas or any other gas or gaseous mixture with adequate reducing potential, such as for example, carbon monoxide, while in the second step the reducing agent, also named oxygen getter, is a refractory or reactive metal or metal alloy and/or a hydride of a refractory or reactive metal such as niobium, tantalum, zirconium, and preferably niobium or tantalum.

The niobium pentoxide (Nb₂O₅) used in the first reduction step may have any shape or size. Preferably, the niobium pentoxide (Nb₂O₅) may be in the form of powders or agglomerated particles. Examples of the types of powders that can be used include, but are not limited to these examples, flaked, rod-like, angular, nodular, sponge-like powder types and/or a mixture or variations thereof. Preferably, the niobium pentoxide (Nb₂O₅) should be in the form of a powder with adequate porosity that more effectively leads to the niobium dioxide (NbO₂).

Examples of the preferred niobium pentoxide (Nb₂O₅) powders are those having mesh sizes from 2.0 millimeters to 0.04 millimeters (10 Mesh Tyler and 325 Mesh Tyler).

The first reduction step tales place in an atmosphere of hydrogen gas or a combination of hydrogen gas with other inert gasses in various ratios, such as for example argon, helium, and nitrogen, or any gas or gaseous mixture having an adequate reducing potential, such as for example, the carbon monoxide. The pressure of the gasses during the process may vary from 13,3 to 266,6 kPa (100 to 2000 Torr) and preferably from 13,3 to 160 kPa (100 to 1200 Torr).

The temperature and the time of the first reduction step should be adequate to warrant the reduction of the niobium pentoxide (Nb₂O₅) to niobium dioxide (NbO₂). Usually, the reaction may be conducted at a temperature between 700° C. and 1500° C., and preferably between 800° C. and 1200° C., for periods of time varying from 15 to 300 minutes, and preferably from 30 to 180 minutes. After the end of the reaction, the product of the reaction is cooled in the process atmosphere until it reaches ambient temperature.

The first reduction step may be conducted in muffle-type furnaces, retort-type furnaces, bogie-hearth furnaces, continuous conveyor belt hearth furnaces or any other type of equipment capable of achieving the required temperatures and of maintaining the reducing atmosphere required for the process.

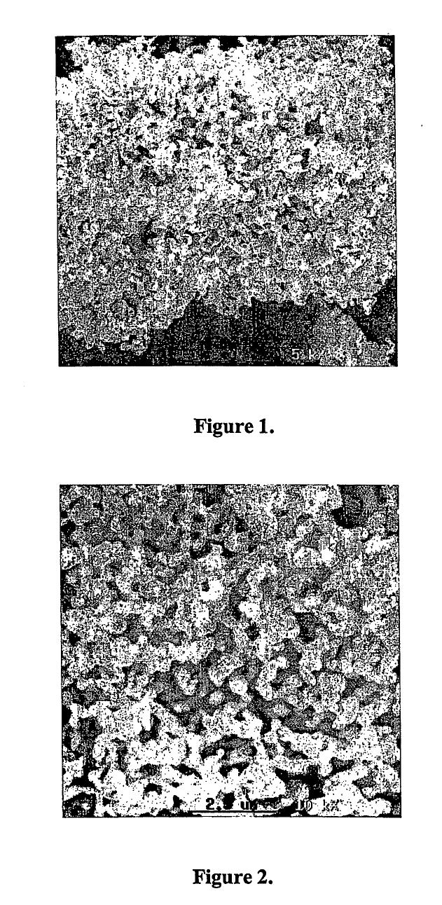

The product of the first reduction step consists in niobium dioxide (NbO₂). The niobium dioxide (NbO₂) produced has preferably a sponge-like morphology, with primary particles of 1 micron or less and binding “neck” between particles of adequate diameter. This product has a convenient porosity allowing to achieve high levels of capacitance when transformed into capacitor anodes. The scanning electron microscopy images of FIGS. 1 and 2 show the type of niobium (NbO₂) of the present invention. As may be seen in these images, the niobium dioxide (NbO₂) of the present invention has a large specific surface area and a porous structure with at least 50% porosity when measured by mercury porometry. The niobium dioxide (NbO₂) of the present invention may be physically characterized as having a specific surface area of 0.5 to 20.0 m²/g, and preferably 0,8 to 12,0 m²/g.

With the first reduction step there is obtained niobium dioxide (NbO₂) with controlled porosity and specific surface area. This control may be achieved by means of proper selection of the niobium pentoxide (Nb₂O₅) and by controlling the process variables—time, temperature and pressure of the reaction.

In the second reaction step the niobium dioxide (NbO₂) obtained from the first reaction step is mixed with the oxygen getter material. The oxygen getter material, for the purposes of the present invention, may be any material capable of reducing the niobium dioxide (NbO₂) specified in the process to niobium monoxide (NbO). Preferentially the oxygen getter material consists in a refractory or reactive metal or metal alloy and/or hydrides thereof, there being preferred the use of niobium and/or tantalum, and niobium being the most preferred one. For the purposes of the present invention, the niobium as used as the oxygen getter is any material containing metallic niobium capable of removing or reducing the oxygen present in the niobium dioxide (NbO₂). Therefore, the niobium used as the getter material may consist in an alloy or a material containing a mixture of niobium with other components. Preferentially, the getter niobium is predominantly, if not exclusively, comprised of metallic niobium. The purity of this niobium is not important, but preferentially there is used metallic niobium of high purity to avoid introducing other impurities during the process.

The oxygen getter material may have any shape or size. Preferentially, the getter material is in the form of powder, in order to have sufficient surface area to function properly as an oxygen getter. Therefore, the getter material may consist in a powder with angular, flaked, rod-like, nodular or sponge-like shape, and/or a mixture or variations of these shapes. Preferentially, the getter material is a hydride of niobium and/or metallic niobium, in the form of granules that may be easily separated by sieving the niobium monoxide powder produced.

A sufficient amount of getter material should be present to reduce the niobium dioxide (NbO₂) to niobium monoxide (NbO). Preferentially, the amount of getter material present in the reaction with the niobium dioxide (NbO₂) is 1 to 6 times the stoichiometric quantity for fully reducing the niobium dioxide (NbO₂) to niobium monoxide (NbO).

The second reaction step is performed in furnaces or reactors commonly used for processing of niobium and/or tantalum, such as, for example, electric vacuum furnaces. The reaction of the niobium dioxide (NbO₂) with the getter material is conducted at a temperature and for a time that are sufficient to allow the reduction of niobium dioxide to niobium monoxide (NbO) to occur. The temperature and the time duration of the process are dependent on several factors, such as, for example, the amount, the morphology and the particle-size distribution of the niobium dioxide and of the getter material loaded; and on the form of mixture of these materials. The temperature of the process may be between 1000° C. and 1700° C., and preferably between 1200° C. and 1600° C., for periods of time between 10 minutes and 720 minutes, and preferentially between 30 minutes and 360 minutes.

The second reduction step is conducted in an atmosphere that allows the transfer of the oxygen atoms of the niobium dioxide (NbO₂) to the oxygen getter material. The reaction is conducted in an atmosphere containing hydrogen gas, and preferably consisting only in hydrogen gas. Other gasses may be present in addition to the hydrogen, such as nitrogen and/or argon and/or helium, provided that these gasses do not lower the reducing potential of the hydrogen. The pressure of the gasses during the second reducing step is preferably from 100 Torr to 2000 Torr, and most preferably from 500 Torr to 1500 Torr.

The niobium monoxide (NbO) of the present invention, produced in the second reaction step, exhibits an atomic rate of niobium to oxygen between 1:0.6 and 1:1.5 and preferably an atomic rate of niobium to oxygen between 1:0.7 and 1:1.1. Putting another way, the niobium monoxide has a formulation between NbO_{0.6} and NbO_{1.5} and preferentially a formulation between NbO_{0.7} and NbO_{1.1}.

The product of the second reduction step is niobium monoxide (NbO), with a morphology similar to the feed material, niobium dioxide (NbO₂). Thus, by controlling the morphology, porosity and particle distribution of the niobium dioxide (NbO₂), it is possible to obtain niobium monoxide (NbO) with adequate characteristics for the manufacture of capacitors.

The advantage of using niobium dioxide as a raw material for the 2^{nd} reduction step resides in that its melting temperature is substantially higher than the melting temperature of niobium pentoxide. This higher melting temperature of the niobium dioxide causes the morphology of the particles to remain practically unchanged during the final reduction reaction, which is conducted under high temperature.

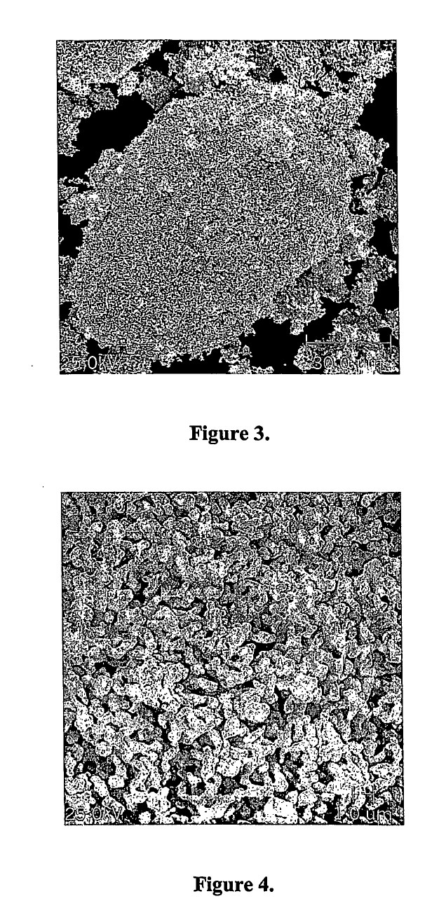

The niobium monoxide (NbO) produced has preferentially a sponge-like morphology, with primary particles of 1 micron or less and a binding “neck” between particles having an adequate diameter. This product has a convenient porosity allowing to achieve high levels of capacitance when used to make capacitor anodes. The scanning electron microscopy images of FIGS. 3 and 4 depict the type of niobium monoxide (NbO) of the present invention. As may be seen in these images, the niobium monoxide (NbO) of the present invention has a large specific surface area and a porous structure with at least 50% porosity. The niobium monoxide (NbO) according to the present invention may be physically characterized as having a specific surface area of 0.5 to 20.0 m²/g, and preferably of 0.8 to 6.0 m²/g.

The niobium monoxide (NbO) according to the present invention was also characterized by its electrical properties resulting from the manufacture thereof as a capacitor anode. The capacitor anode may be manufactured by pressing powders of niobium monoxide (NbO) to form anodes, and sintering those anodes at appropriate temperatures and anodizing the same to produce electrolytic capacitor anodes that may be tested as to their electrical properties.

The anodes produced by pressing powders of niobium monoxide (NbO) according to the present invention had a mass of 100 mg. They were sintered in vacuum at about 6.7×10⁻³ Pa (5.0×10⁻⁵ Torr), at a temperature of 1400° C. for 10 minutes. The anodizing was carried out in a solution of H₃PO₄ at 0.1% (by mass) and the anodizing voltage used was 30 Volts. The capacitance after anodizing was measured using a bridge LCR Agilent 4284A, the electrolyte used was a solution of H₂SO₄ at 18% (by mass) and the frequency used was 120 Hz. The current leakage measurement was conducted in a solution of H₃PO₄ at 0.1% (by mass), the voltage used corresponded to 70% of the anodizing voltage, that is, 21 Volts, and the current was monitored until 180 seconds after application of the voltage.

The invention is explained in further detail by means of the examples described in the following:

### EXAMPLE 1

First reduction step: 200 grams of powdered niobium pentoxide were loaded into a tubular furnace. Hydrogen gas was admitted to the furnace chamber, and the furnace temperature was raised from ambient temperature to 800° C. The load was kept at this temperature for 300 minutes, whereupon the heating was turned off. The hydrogen atmosphere was maintained until the load reached ambient temperature, whereupon the furnace chamber was pressurized with nitrogen prior to removal of the load from the furnace. The product of this first reaction step had the following properties:

X-Ray Diffraction: NbO₂

Specific surface area, BET analysis method: 3.2 m²/g

Porosity: 83.8%

Second reduction step: 6 grams of niobium dioxide, produced in the first reduction step, were loaded into a niobium crucible, together with 34 g of powdered niobium hydride with particle size of less than 0.6 mm and greater than 0.3 mm. The crucible containing the mixture was loaded into the chamber of an electric vacuum furnace, the furnace chamber was evacuated and thereafter was pressurized with hydrogen gas to a pressure of 4 kPa (30 Torr) above atmospheric pressure. The temperature was raised from ambient temperature to a reaction temperature of 1200° C. and kept at that level for 180 minutes. Upon there having elapsed the period of 180 minutes, the furnace was turned off and the furnace chamber was evacuated until there was reached a pressure of 0.067 Pa (5×10⁻⁴ Torr). The furnace chamber was awaited to cool until ambient temperature prior to pressurizing the same with nitrogen. After the pressurization, the chamber was opened and the load was withdrawn from the furnace. The niobium monoxide powder was separated from the getter material powder by sieving using a screen with 0.2 mm mesh size. The product was tested and the following results were obtained:

X-Ray Diffraction: NbO

Specific surface area, BET analysis method: 1.1 m²/g

Capacitance: 77,133 CV/g

Current Leakage: 0.2 nA/CV

Chemical analysis (ppm)

| | |
|---|---|
| C = | 59 |
| B | <3 |
| Ca = | 11 |
| Cr = | 7 |
| Fe | <5 |
| H₂ = | 49 |
| Mg = | 6 |
| Mn = | 4 |
| N₂ = | 70 |
| Ni | <10 |
| Si = | 154 |
| Ta = | 1334 |
| Zr | <2 |

### EXAMPLE 2

First reduction step: 250 grams of powdered niobium pentoxide were loaded into a tubular furnace. Hydrogen gas was admitted to the furnace chamber, and the furnace temperature was raised from ambient temperature to 800° C. The load was kept at this temperature for 150 minutes, whereupon the heating was turned off. The hydrogen atmosphere was maintained until the load reached ambient temperature, whereupon the furnace chamber was pressurized with nitrogen prior to removal of the load from the furnace. The product of this first reaction step had the following properties:

X-Ray Diffraction: NbO₂

Specific surface area, BET analysis method: 3.5 m²/g

Porosity: 84.4%

Second reduction step: 180 grams of niobium dioxide, produced in the first reduction step, were loaded into a niobium crucible, together with 1000 g of powdered niobium hydride with particle size of less than 0.6 mm and greater than 0.3 mm. The crucible containing the mixture was loaded into the chamber of an electric vacuum furnace, the furnace chamber was evacuated and thereafter was pressurized with hydrogen gas to a pressure of 4 kPa (30 Torr) above atmospheric pressure. The temperature was raised from ambient temperature to a reaction temperature of 1200° C. and kept at that level for 180 minutes. Upon there having elapsed the period of 180 minutes, the furnace was turned off and the furnace chamber was evacuated until there was reached a pressure of 0.067 Pa (5×10⁻⁴ Torr). The furnace chamber was awaited to cool until ambient temperature prior to pressurizing the same with nitrogen. After the pressurization, the chamber was opened and the load was withdrawn from the furnace. The niobium monoxide powder was separated from the getter material powder by sieving using a screen with 0.2 mm mesh size. The product was tested and the following results were obtained:

X-Ray Diffraction: NbO

Specific surface area, BET analysis method: 1.9 m²/g

Capacitance: 62,257 CV/g

Current Leakage: 0.5 nA/CV

Chemical analysis (ppm)

| | |
|---|---|
| C = | 46 |
| B | <3 |
| Ca = | 54 |
| Cr = | 5 |
| Fe = | 35 |
| H₂ = | 112 |
| Mg = | 8 |
| Mn = | 8 |
| N₂ = | 10 |
| Ni | <10 |
| Si = | 141 |
| Ta = | 1242 |
| Zr | <2 |

### EXAMPLE 3

First reduction step: 1000 grams of powdered niobium pentoxide were loaded into a tubular furnace. Hydrogen gas was admitted to the furnace chamber, and the furnace temperature was raised from ambient temperature to 800° C. The load was kept at this temperature for 90 minutes, whereupon the heating was turned off. The hydrogen atmosphere was maintained until the load reached ambient temperature, whereupon the furnace chamber was pressurized with nitrogen prior to removal of the load from the furnace. The product of this first reaction step had the following properties:

X-Ray Diffraction: NbO₂

Specific surface area, BET analysis method: 7.0 m²/g

Porosity: 80.4%

Second reduction step: 890 grams of niobium dioxide, produced in the first reduction step, were loaded into a niobium crucible, together with 5000 g of powdered niobium hydride with particle size of less than 0.6 mm and greater than 0.3 mm. The crucible containing the mixture was loaded into the chamber of an electric vacuum furnace, the furnace chamber was evacuated and thereafter was pressurized with hydrogen gas to a pressure of 4 kPa (30 Torr) above atmospheric pressure. The temperature was raised from ambient temperature to a reaction temperature of 1200° C. and kept at that level for 360 minutes. Upon there having elapsed the period of 360 minutes, the furnace was turned off and the furnace chamber was evacuated until there was reached a pressure of 0.067 Pa (5×10⁻⁴ Torr). The furnace chamber was awaited to cool until ambient temperature prior to pressurizing the same with nitrogen. After the pressurization, the chamber was opened and the load was withdrawn from the furnace. The niobium monoxide powder was separated from the getter material powder by sieving using a screen with 0.2 mm mesh size. The product was tested and the following results were obtained:

X-Ray Diffraction: NbO

Specific surface area, BET analysis method: 1.1 m²/g

Capacitance: 91,737 CV/g

Current Leakage: 0.2 nA/CV

Chemical analysis (ppm)

| | |
|---|---|
| C | <30 |
| B | <3 |
| Ca = | 6 |
| Cr | <4 |
| Fe | <5 |
| H₂ = | 243 |
| Mg = | 4 |
| Mn = | 3 |
| N₂ | <10 |
| Ni | <10 |
| Si = | 145 |
| Ta = | 1357 |
| Zr | <2 |

### EXAMPLE 4

First reduction step: 500 grams of powdered niobium pentoxide were loaded into a tubular furnace. Hydrogen gas was admitted to the furnace chamber, and the furnace temperature was raised from ambient temperature to 900° C. The load was kept at this temperature for 150 minutes, whereupon the heating was turned off. The hydrogen atmosphere was maintained until the load reached ambient temperature, whereupon the furnace chamber was pressurized with nitrogen prior to removal of the load from the furnace. The product of this first reaction step had the following properties:

X-Ray Diffraction: NbO2

Specific surface area, BET analysis method: 1.6 m²/g

Porosity: 77.0%

Second reduction step: 6 grams of niobium dioxide, produced in the first reduction step, were loaded into a niobium crucible, together with 34 g of powdered niobium hydride with particle size of less than 0.6 mm and greater than 0.3 mm. The crucible containing the mixture was loaded into the chamber of an electric vacuum furnace, the furnace chamber was evacuated and thereafter was pressurized with hydrogen gas to a pressure 4 kPa (30 Torr) above atmospheric pressure. The temperature was raised from ambient temperature to the reaction temperature of 1300° C. and kept at that level for 180 minutes. Upon there having elapsed the period of 180 minutes, the furnace was turned off and the furnace chamber was evacuated until there was reached a pressure of 0.067 kPa (5×10⁻⁴ Torr). The furnace chamber was awaited to cool until ambient temperature prior to pressurizing the same with nitrogen. After the pressurization, the chamber was opened and the load was withdrawn from the furnace. The niobium monoxide powder was separated from the getter material powder by sieving using a screen with 0.2 mm mesh size. The product was tested and the following results were obtained:

X-Ray Diffraction: NbO

Specific surface area, BET analysis method: 1.2 m²/g

Capacitance: 91,600 CV/g

Current Leakage: 0.3 nA/CV.

1. A process for the production niobium monoxide powder characterized by comprising two reduction steps of niobium oxide, the first step comprises reducing by hydrogen of niobium pentoxide to niobium dioxide, and the second step comprises reducing niobium dioxide to niobium monoxide, by using an oxygen getter material and in an atmosphere which allows the transfer of the oxygen atoms from the niobium dioxide to the getter material, wherein the getter material can be a refractory metal or a reactive metal or a refractory metal or a reactive metal hydride.

2. A process for the production of niobium monoxide powder, according to claim 1, characterized in that the first reduction step is conducted at a temperature between 700° C. and 1500° C., and preferably between 800° C. and 1200° C., for periods of time varying from 15 to 300 minutes, and preferably between 30 and 180 minutes.

3. A process for the production of niobium monoxide powder, according to claim 1, characterized in that the first reduction step is conducted in an atmosphere of hydrogen gas or a combination of hydrogen gas and other inert gasses at various ratios, such as, argon, helium and nitrogen.

4. A process for the production of niobium monoxide powder, according to claim 1, characterized in that the first reduction step is conducted in an atmosphere of carbon monoxide or any other gas or gaseous mixture having an adequate reducing potential.

5. A process for the production of niobium monoxide powder, according to claim 1 characterized by producing in the first reduction step the niobium dioxide with a microporous structure, with a specific surface area between 0.5 m²/g and 20 m²/g.

6. A process for the production of niobium monoxide powder, according to claim 1, characterized by producing in the first reduction step the niobium dioxide with a microporous structure, with at least 41 percent porosity.

7. A process for the production of niobium monoxide powder, according to claim 1, characterized by producing in the first reduction step the niobium dioxide with a microporous structure, with low residual content of niobium pentoxide.

8. A process for the production of niobium monoxide powder, according to claim 1, characterized by using in the second reduction step the niobium dioxide with a specific surface area between 0.5 and 20 m²/g.

9. A process for the production of niobium monoxide powder, according to claim 1, characterized by using in the second reduction step the niobium dioxide with at least 41 percent porosity.

10. A process for the production of niobium monoxide powder, according to claim 1, characterized by using as oxygen getter material in the second reduction step the niobium metal and alloys thereof, and/or niobium metal and its alloys hydride thereof in the form of powder.

11. A process for the production of niobium monoxide powder, according to claim 1, characterized by using as oxygen getter material in the second reduction step the tantalum metal and alloys thereof, and/or tantalum metal and its alloys hydride thereof in the form of powder.

12. A process for the production of niobium monoxide powder, according to claim 1, characterized in that the atmosphere that allows the transfer of the oxygen atoms in the second reduction step is comprised of hydrogen gas, and may contain other gasses that do not lower the reducing potential of the hydrogen gas.

13. A process for the production of niobium monoxide powder, according to claim 1, characterized in that the atmosphere of the second reduction step is comprised of hydrogen gas and nitrogen in such a way that allow the nitrogen doping of the formed niobium monoxide.

14. A process for the production of niobium monoxide powder, according to claim 1, characterized in that the second reduction step is conducted at a temperature between 1000° C. and 1700° C., and preferably between 1200° C. and 1600° C., for periods of time between 10 minutes and 720 minutes, and preferably between 30 minutes and 360 minutes.

15. A process for the production of niobium monoxide powder, according to claim 1, characterized in that the niobium monoxide that is produced does not contain detectable residual amounts of niobium dioxide or metallic niobium by X-ray diffraction.

16. A process for the production of niobium monoxide powder, according to claim 1, characterized in that the niobium monoxide produced in the second reduction step has similar morphology of the niobium dioxide.

17. A process for the production of niobium monoxide powder, according to claim 1, characterized in that the niobium monoxide produced in the second reduction step has an atomic ratio between niobium and oxygen between 1:0.6 e 1:1.5 and preferably an atomic ratio between niobium and oxygen between 1:0.7 and 1:1.1.

18. Niobium monoxide, produced in accordance with claim 1, characterized by presenting a residual content of up to 5 percent of niobium dioxide.

19. Niobium monoxide, produced in accordance with claim 1, characterized by presenting a residual content of up to 5 percent of niobium metal.

20. Niobium monoxide, produced in accordance with claim 1, characterized by presenting a residual content of up to 5 percent of niobium dioxide and a residual content of up to 5 percent of niobium metal.

21. Niobium monoxide, produced in accordance with claim 1, characterized by having a specific surface area from 0.5 to 20.0 m²/g, preferably from 0.8 to 6.0 m²/g.

22. Niobium monoxide, produced in accordance with claim 1, characterized by having a microporous structure with at least 41 percent porosity.

23. A capacitor, manufactured with niobium monoxide produced according to claim 1, characterized by having a capacitance between 50,000 CV/g and 200,000 CV/g.

24. A capacitor, manufactured with the niobium monoxide produced according to claim 1, characterized by having a leakage current value below 1.0 nA/CV
